(19) United States
(12) Patent Application Publication
(10) Pub. No.: US 2009/0024377 A1
(43) Pub. Date: Jan. 22, 2009

(54) System and Method for Modeling Semiconductor Devices Using Pre-Processing

(76) Inventor: Sung-Ki Min, Cupertino, CA (US)

Correspondence Address: BAKER BOTTS L.L.P., 2001 ROSS AVENUE, SUITE 600, DALLAS, TX, 75201-2980, US

(21) Appl. No.: 11/778,454

(22) Filed: Jul. 16, 2007

(51) Int. Cl. G06G 7/62

(52) U.S. Cl. 703/13

(57) ABSTRACT

A system for modeling a semiconductor device comprises a pre-processing module and a simulation module. The pre-processing module stores at least one virtual model equation associated with at least one terminal of a semiconductor device. The pre-processing module receives an actual voltage value associated with the at least one terminal. The pre-processing module then calculates at least one modified voltage value for the at least one terminal based at least in part upon the virtual model equation and the actual voltage value. The simulation module receives the modified voltage value, and generates a simulation result for the semiconductor device based at least in part upon the modified voltage value.

### TECHNICAL FIELD OF THE INVENTION

This invention relates in general to modeling semiconductor devices, and more particularly to a system for modeling semiconductor devices using data pre-processing.

### BACKGROUND OF THE INVENTION

Commercial circuit simulation tools, such as SPICE and HSPICE, do not accurately model non-traditional integrated circuits (Ics), including semiconductor devices, because the modeling equations that they use are incomplete. Moreover, the modeling equations used by such commercial circuit simulation tools are inaccessible to users, and therefore cannot be readily modified. As a result, the current-voltage characteristics provided by these simulation tools do not accurately model the operation of all semiconductor devices.

### SUMMARY OF THE INVENTION

In accordance with the present invention, the disadvantages and problems associated with prior circuit simulation tools have been substantially reduced or eliminated.

In accordance with one embodiment of the present invention, a system for modeling a semiconductor device comprises a pre-processing module and a simulation module. The pre-processing module stores at least one virtual model equation associated with at least one terminal of a semiconductor device. The pre-processing module receives an actual voltage value associated with the at least one terminal. The pre-processing module then calculates at least one modified voltage value for the at least one terminal based at least in part upon the virtual model equation and the actual voltage value. The simulation module receives the modified voltage value, and generates a simulation result for the semiconductor device based at least in part upon the modified voltage value.

Another embodiment of the present invention is a pre-processing module for modeling a semiconductor device that comprises a memory and a processor. The memory stores at least one virtual model equation associated with at least one terminal of a semiconductor device. The processor receives an actual voltage value associated with the at least one terminal, and calculates at least one modified voltage value for the at least one terminal based at least in part upon the virtual model equation and the actual voltage value. The processor then communicates the modified voltage value to a simulation module that generates a simulation result for the semiconductor device based at least in part upon the modified voltage value.

Yet another embodiment of the present invention is a method for modeling a semiconductor device. The method comprises storing at least one virtual model equation associated with at least one terminal of a semiconductor device. The method proceeds by receiving an actual voltage value associated with the at least one terminal, and calculating at least one modified voltage value for the at least one terminal based at least in part upon the virtual model equation and the actual voltage value. The method concludes by generating a simulation result for the semiconductor device based at least in part upon the modified voltage value.

The following technical advantages may be achieved by some, none, or all of the embodiments of the present invention.

By using a pre-processing module prior to a simulation module, the present invention is able to modify the inputs used for a simulation. In this way, the system of the present invention is able to simulate the operation of non-traditional semiconductor devices, such as junction field effect transistors, without altering the software or equations used by commercial circuit simulation tools.

These and other advantages, features, and objects of the present invention will be more readily understood in view of the following detailed description, drawings, and claims.

### BRIEF DESCRIPTION OF THE DRAWINGS

For a more complete understanding of the present invention and its advantages, reference is now made to the following descriptions, taken in conjunction with the accompanying drawings, in which:

FIG. 1 illustrates one embodiment of a system for modeling a semiconductor device;

FIG. 2 illustrates one embodiment of a method for modeling a semiconductor device; and

FIG. 3 illustrates one embodiment of simulation results according to the present invention.

### DETAILED DESCRIPTION OF THE INVENTION

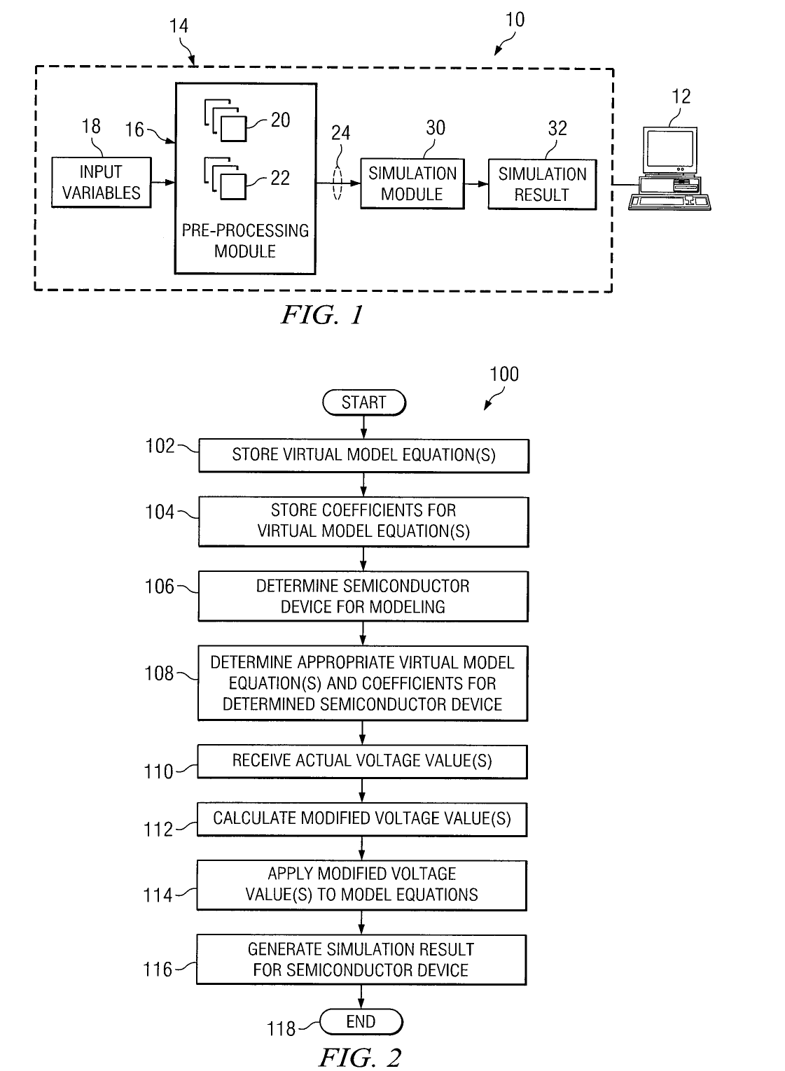

FIG. 1 illustrates one embodiment of a system 10 for modeling an integrated circuit, including a semiconductor device. System 10 comprises a computer 12 that performs a modeling operation 14. In general, a preprocessing module 16 receives input variables 18, such as actual voltage values associated with one or more terminals of a semiconductor device. Preprocessing module 16 uses one or more virtual model equations 20 and one or more coefficients 22 to calculate one or more modified voltage values 24 for communication to simulation module 30. Simulation module 30 receives the modified voltage values 24 and generates simulation result 32 based at least in part upon modified voltage values 24. By modifying the inputs used to perform a simulation, system 10 is able to simulate the operation of non-traditional semiconductor devices, such as junction field effect transistors, without altering the software or equations used by commercial circuit simulation tools, such as simulation module 30.

Computer 12 comprises an input device, such as a keypad, touch screen, mouse, or other device that can accept information. Computer 12 further comprises an output device that conveys information associated with the operation of computer 12, including data, visual information, or audio information. For example, computer 12 may graphically display simulation result 32 using its output device. Computer 12 may further include fixed or removable storage media such as a magnetic computer disk, CD-ROM, or other suitable media to both receive output from and provide input to computer 12. Furthermore, computer 12 comprises a processor and associated memory comprising a central processing unit associated with an operating system that executes instructions and manipulates information in accordance with the operation of system 10.

Computer 12 maintains and executes instructions to implement modeling operation 14, including preprocessing module 16 and simulation module 30, as well as input variables 18 and simulation result 32. Computer 12 may also store and use information regarding any number and type of semiconductor devices to be modeled. Each module described above with reference to computer 12 comprises any suitable combination of hardware and software in computer 12 to provide the described function or operation of the module. For example, modules 16 and 30 may include program instructions and associated memory and processing components to execute the program instructions. Also, modules illustrated in FIG. 1 may be separate from or integral to other modules.

Simulation module 30 comprises a circuit simulation tool, such as SPICE or HSPICE, or any other suitable circuit design and/or modeling tool. Modeling for semiconductor devices is typically performed by building an equation which describes the current-voltage characteristics of the device using model parameter coefficients. However, commercial circuit simulation tools do not provide accurate simulation results for non-traditional semiconductor devices because the model equations that are used by the circuit simulation tool are incomplete or inaccurate. Moreover, the existing model equations built into the commercial simulation tools are not accessible and cannot be changed or improved by users of the tool.

As a result, system 10 uses preprocessing module 16 in order to make the simulation result 32 of simulation module 30 more accurate. In particular, preprocessing module 16 comprises one or more virtual model equations 20 and one or more coefficients 22 that are used to modify input variables 18 prior to the modeling performed by simulation module 30. Input variables 18 comprise the actual voltage values used to operate a semiconductor device. These actual voltage values may be associated with one or more of the source terminal, drain terminal, gate terminal, and body terminal of the semiconductor device. Typically, these input variables are generated by users of the circuit simulation tool or received from a test file, or the like.

A semiconductor device, such as a JFET, includes multiple terminals, such as a source terminal, a drain terminal, a gate terminal, and a body terminal. For each of these terminals, a virtual model equation 20 and associated coefficients 22 may be used in preprocessing module 16. For example, the virtual model equation 20 for a body terminal of a JFET may comprise:

V(bm)=K0+K1*V(b)+K2*V(b)²

where: V(bm) is the virtual body node voltage, V(b) is the actual body node voltage, and K0, K1, K2 are coefficients 22. When modeling the JFET, preprocessing module 16 receives an input variable 18, such as the actual body node voltage V(b), and generates a modified voltage value 24, such as virtual body node voltage V(bm), using virtual model equation 20 and coefficients 22. Simulation module 30 then uses virtual body node voltage V(bm) in its model equations rather than actual body node voltage V(b). In this way, preprocessing module 16 in combination with simulation module 30 generates a more accurate simulation result 32 for modeling a non-traditional semiconductor device, such as a JFET.

The modified voltage values 24 are adjusted in a known way so that when they are used by simulation module 30, it creates simulation results 32 that are more accurate for the particular semiconductor device being modeled. Therefore, rather than attempting to modify the model equations used by simulation module 30, system 10 modifies the inputs of simulation module 30. The modified voltage values 24 may be formatted, as appropriate, to meet the requirements, if any, of the simulation module 30.

Although the equation set forth above is related to a virtual body node of the semiconductor device, other virtual model equations 20 may also be used for any number and combination of the source node, drain node, and gate node. In particular, pre-processing module 16 may use virtual model equations 20 to create: a virtual source node voltage (Vsm) from an actual source node voltage V(s); a virtual drain node voltage (Vdm) from an actual drain node voltage V(d); and a virtual gate node voltage (Vgm) from an actual gate node voltage (V(g). Moreover, each of these additional virtual model equations 20 may be associated with corresponding coefficients 22. In this way, preprocessing module 16 may be able to adjust input variables 18 across multiple dimensions and thereby provide even more accurate simulation results 32 from simulation module 30.

In addition, although the equation set forth above is illustrated as a second order series, the virtual model equations 20 may comprise any suitable multiple order series that yields a simulation result 32 that models the operation of the semiconductor device within a predetermined threshold of accuracy. For example, any or all of the virtual model equations 20 may comprise a second order series, a third order series, a fourth order series, and so on.

In a particular embodiment, the coefficients 22 that are used in corresponding virtual model equations 20 are determined in an iterative process to provide a best fit of the simulation results 32 with the operation of the semiconductor device. For example, particular coefficients 22 may be used in a particular virtual model equation 20 and a corresponding simulation result 32 for the semiconductor device may be observed. Based at least in part upon the accuracy of simulation result 32 in comparison with a known operation of the semiconductor device, one or more of the coefficients 22 may be adjusted. These adjustments of coefficients 22 may be performed in any suitable number of iterations until the simulation result 32 is within a predetermined threshold of accuracy in comparison with the known operation of the corresponding semiconductor device 10. The threshold for accuracy can be determined on a case-by-case basis according to various parameters important to the circuit designer. Once a particular set of coefficients 22 is determined for a given virtual model equation 20 associated with a particular semiconductor device, preprocessing module 16 stores the coefficients 22 for subsequent use during modeling operation 14. Simulation module 30 generates simulation result 32 based upon modified voltage values 24 calculated using one or more virtual model equations 20 and coefficients 22.

FIG. 2 illustrates one embodiment of a method for modeling a semiconductor device. The method begins at step 102 where computer 12 stores virtual model equations 20 for a variety of semiconductor devices. As described above, the virtual model equations 20 may be associated with any number and combination of source terminals, gate terminals, drain terminals and body terminals of a semiconductor device, such as a JFET. Computer 12 further stores coefficients 22 for the virtual model equations 20 at step 104. Computer 12 determines the particular semiconductor device to be modeled at step 106 and determines the appropriate virtual model equations 20 and coefficients 22 for the determined semiconductor device at step 108. At step 110, computer 12 receives the actual voltage values associated with one or more terminals of the semiconductor device to be modeled.

Execution proceeds to step 112 where computer 12 calculates modified voltage values 24 based at least in part upon the virtual model equations 20 and coefficients 22 determined at step 108. The modified voltage values 24 may be associated with voltages to be applied to any number and combination of a source terminal, a gate terminal, a drain terminal, and a body terminal of the semiconductor device. At step 114, computer 12 applies modified voltage values 24 to the model equations associated with simulation module 30. For example, the model equations of simulation module 30 may be equations that are built into a circuit simulation tool, such as HSPICE. Execution proceeds to step 116 where computer 12 generates simulation result 32 for the semiconductor device. The simulation result 32 may be represented as data or as a graphical display, as appropriate. In either instance, simulation result 32 provides a relationship between current and voltage. The method ends at step 118.

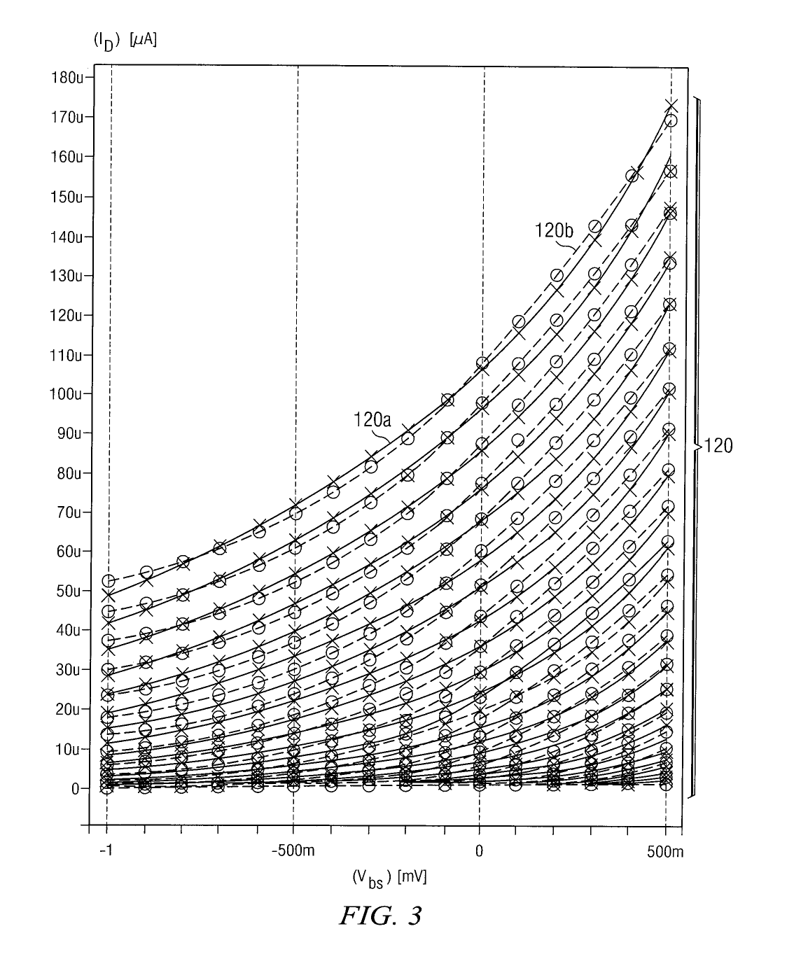

FIG. 3 illustrates one embodiment of simulation result 32 generated using modeling operation 14 for a particular semiconductor device. In this embodiment, simulation result 32 is illustrated as a series of curves 120 associated with data points that map a drain current, ID, associated with a y-axis, with a body-source bias voltage, V_{bs}, associated with an x-axis. Each of curves 120 is associated with the application of a different gate voltage to the semiconductor device. Moreover, solid curves 120a are associated with the actual operation of the semiconductor device, whereas dashed curves 120b are associated with a semiconductor device simulated according to modeling operation 14. As can be seen from FIG. 3, the simulation result 32 associated with dashed curves 120b closely approximates the actual operation of the semiconductor device.

Although the present invention has been described in detail, it should be understood that various changes, substitutions and alterations can be made hereto without departing from the sphere and scope of the invention as defined by the appended claims.

What is claimed is:

1. A system for modeling a semiconductor device, comprising:
a preprocessing module operable to:
store at least one virtual model equation associated with at least one terminal of a semiconductor device;
receive an actual voltage value associated with the at least one terminal; and
calculate at least one modified voltage value for the at least one terminal based at least in part upon the virtual model equation and the actual voltage value; and
a simulation module communicatively coupled to the preprocessing module and operable to:
receive the modified voltage value; and
generate a simulation result for the semiconductor device based at least in part upon the modified voltage value.

2. The system of claim 1, wherein the virtual model equation comprises a multiple order series of exponential functions based at least in part upon the actual voltage value.

3. The system of claim 2, wherein the multiple order series comprises a second order series.

4. The system of claim 2, wherein the multiple order series comprises a third order series.

5. The system of claim 2, wherein the series is selected to have a particular number of orders that yields the simulation result that models the operation of the semiconductor device within a predetermined threshold of accuracy.

6. The system of claim 2, wherein the virtual model equation further comprises a plurality of coefficients, each coefficient associated with a corresponding order of exponential function.

7. The system of claim 6, wherein the coefficients are selected to yield a simulation result that models the operation of the semiconductor device within a pre-determined threshold of accuracy.

8. The system of claim 1, wherein the at least one terminal comprises one of the gate, body, source or drain of the semiconductor device.

9. The system of claim 1, wherein:
the virtual model equation comprises a first virtual model equation and the preprocessing module is further operable to store a second virtual model equation associated with a second terminal of the semiconductor device;
the actual voltage comprises a first actual voltage and the preprocessing module is further operable to receive a second actual voltage associated with the second terminal;
the modified voltage value comprises a first modified voltage value and the preprocessing module is further operable to calculate a second modified voltage value based at least in part upon the second virtual model equation and the second actual voltage value; and
the simulation module is further operable to receive the second modified voltage value and generate the simulation result based further upon the second modified voltage value.

10. The system of claim 9, wherein:
the first terminal comprises one of the gate, body, source or drain of the semiconductor device; and
the second terminal comprises another of the gate, body, source or drain of the semiconductor device.

11. The system of claim 1, wherein:
the preprocessing module is further operable to calculate modified voltage values for any number of other terminals of the semiconductor device based upon a corresponding number of additional virtual model equations and a corresponding number of additional actual voltage values; and
the simulation module is further operable to generate the simulation result based further upon the modified voltage values for the other terminals of the semiconductor device.

12. The system of claim 1, wherein the actual voltage value is associated with at least one of the gate, body, source or drain of the semiconductor device.

13. The system of claim 1, wherein the simulation result comprises current-voltage characteristics associated with the semiconductor device.

14. A preprocessing module for modeling a semiconductor device, comprising:
a memory operable to store at least one virtual model equation associated with at least one terminal of a semiconductor device; and
a processor communicatively coupled to the memory and operable to:
receive an actual voltage value associated with the at least one terminal;
calculate at least one modified voltage value for the at least one terminal based at least in part upon the virtual model equation and the actual voltage value; and
communicate the modified voltage value to a simulation module that generates a simulation result for the semiconductor device based at least in part upon the modified voltage value.

15. The preprocessing module of claim 14, wherein the virtual model equation comprises a multiple order series of exponential functions based at least in part upon the actual voltage value.

16. The preprocessing module of claim 15, wherein the multiple order series comprises a second order series.

17. The preprocessing module of claim 15, wherein the multiple order series comprises a third order series.

18. The preprocessing module of claim 15, wherein the series is selected to have a particular number of orders that yields a simulation result that models the operation of the semiconductor device within a pre-determined threshold of accuracy.

19. The preprocessing module of claim 15, wherein the virtual model equation further comprises a plurality of coefficients, each coefficient associated with a corresponding order of exponential function.

20. The preprocessing module of claim 19, wherein the coefficients are selected to yield a simulation result that models the operation of the semiconductor device within a pre-determined threshold of accuracy.

21. The preprocessing module of claim 14, wherein the at least one terminal comprises one of the gate, body, source and drain of the semiconductor device.

22. The preprocessing module of claim 14, wherein the processor is further operable to:
calculate modified voltage values for any number of other terminals of the semiconductor device based upon a corresponding number of additional virtual model equations and a corresponding number of additional actual voltage values; and
communicate the modified voltage values to the simulation module such that the simulation result is based further upon the modified voltage values for the other terminals of the semiconductor device.

23. The preprocessing module of claim 14, wherein the actual voltage value is associated with at least one of the gate, body, source and drain of the semiconductor device.

24. The preprocessing module of claim 14, wherein the simulation result comprises current-voltage characteristics associated with the semiconductor device.

25. A method for modeling a semiconductor device, comprising:
storing at least one virtual model equation associated with at least one terminal of a semiconductor device;
receiving an actual voltage value associated with the at least one terminal;
calculating at least one modified voltage value for the at least one terminal based at least in part upon the virtual model equation and the actual voltage value; and
generating a simulation result for the semiconductor device based at least in part upon the modified voltage value.

26. The method of claim 25, wherein the virtual model equation comprises a multiple order series of exponential functions based at least in part upon the actual voltage value.

27. The method of claim 26, wherein the multiple order series comprises a second order series.

28. The method of claim 26, wherein the multiple order series comprises a third order series.

29. The method of claim 26, wherein the series is selected to have a particular number of orders that yields a simulation result that models the operation of the semiconductor device within a pre-determined threshold of accuracy.

30. The method of claim 26, wherein the virtual model equation further comprises a plurality of coefficients, each coefficient associated with a corresponding order of exponential function.

31. The method of claim 30, wherein the coefficients are selected to yield the simulation result that models the operation of the semiconductor device within a pre-determined threshold of accuracy.

32. The method of claim 25, wherein the at least one terminal comprises one of the gate, body, source or drain of the semiconductor device.

33. The method of claim 25, further comprising calculating modified voltage values for any number of other terminals of the semiconductor device based upon a corresponding number of additional virtual model equations and a corresponding number of additional actual voltage values.

34. The method of claim 33, wherein generating the simulation result comprises generating the simulation result based further upon the modified voltage values for the other terminals of the semiconductor device.

35. The method of claim 25, wherein the actual voltage value is associated with at least one of the gate, body, source or drain of the semiconductor device.

36. The method of claim 25, wherein the simulation result comprises current-voltage characteristics associated with the semiconductor device.
